(19) United States
(12) Patent Application Publication
(10) Pub. No.: US 2025/0280359 A1
(43) Pub. Date: Sep. 4, 2025

(54) AUTOMATICALLY SELECTING A NETWORK LINK FOR TRANSFERRING DATA BASED ON LINK PERFORMANCE

(71) Applicant: Motorola Mobility LLC, Chicago, IL (US)

(72) Inventors: Prashanth Chakravarthy, Bangalore (IN); Ranjeet Gupta, Aurora, IL (US)

(73) Assignee: Motorola Mobility LLC, Chicago, IL (US)

(21) Appl. No.: 18/592,985

(22) Filed: Mar. 1, 2024

(51) Int. Cl. H04W 48/18; H04L 43/0888; H04W 84/12

(52) U.S. Cl. CPC H04W 48/18; H04L 43/0888; H04W 84/12

(57) ABSTRACT

Automatically selecting a network link for transferring data based on link performance is discussed herein. The performance of a cellular network link and the performance of a wireless local area network link are determined. If both the wireless local area network link and the cellular network link are available, the one of those two network links having the higher performance is automatically selected to connect to the internet when the electronic device is operating as a mobile hotspot, or to connect to another electronic device in a peer-to-peer (P2P) mode.

### BACKGROUND

As technology has advanced our uses for electronic devices have expanded. One such use is communicating with various other electronic devices, directly or via a network of additional electronic devices. This communication can be the communication of data between devices for users to consume (e.g., read, watch, listen to), control communication (e.g., for one device to control another), and so forth. Various different communication techniques can be used for this communication.

### BRIEF DESCRIPTION OF THE DRAWINGS

Embodiments of automatically selecting a network link for transferring data based on link performance are described with reference to the following drawings. The same numbers are used throughout the drawings to reference like features and components:

FIG. 1 illustrates an example electronic device implementing the techniques discussed herein;

FIG. 2 illustrates an example system implementing the techniques discussed herein;

FIG. 3 illustrates another example system implementing the techniques discussed herein;

FIG. 4 illustrates an example process for implementing the techniques discussed herein in accordance with one or more embodiments;

FIG. 5 illustrates another example process for implementing the techniques discussed herein in accordance with one or more embodiments;

FIG. 6 illustrates various components of an example electronic device that can implement embodiments of the techniques discussed herein.

### DETAILED DESCRIPTION

Automatically selecting a network link for transferring data based on link performance is discussed herein. Generally, electronic devices such as cell phones can operate as mobile hotspots for other devices to connect to the internet. Connection to the internet can be, for example, via a wireless local area network (e.g., a WiFi™ link) or a cellular network (e.g., a 4^{th} generation (4G) or 5^{th} generation (5G) link). If both a wireless local area network link and a cellular network link are available to the electronic device, one solution is for the electronic device to default to using the wireless local area network link. However, this can lead to situations where a lower performance wireless local area network (e.g., capable of 10 megabits per second (Mbps) data throughput) is used to connect to the internet despite a higher performance cellular network (e.g., capable of 1 gigabit per second (Gps) data throughput) being available to the electronic device.

In contrast, using the techniques discussed herein the performance of the cellular network link and the performance of the wireless local area network link are determined. These performances can be determined in various manners, and in one or more implementations are theoretical performances. If both the wireless local area network link and the cellular network link are available, the one of those two network links having the higher performance is automatically selected to connect to the internet when the electronic device is operating as a mobile hotspot. These techniques can also be used in other scenarios, such as when using the electronic device to communicate with another electronic device using a peer-to-peer (P2P) coupling.

The techniques discussed herein improve the operation of an electronic device by automatically using the higher performance one of the wireless local area network link and the cellular network link to connect to the internet when operating as a mobile hotspot, when communicating with another electronic device using a P2P coupling, and so forth. This improves data transfer speed and communication between the electronic device and other devices on the internet or using P2P.

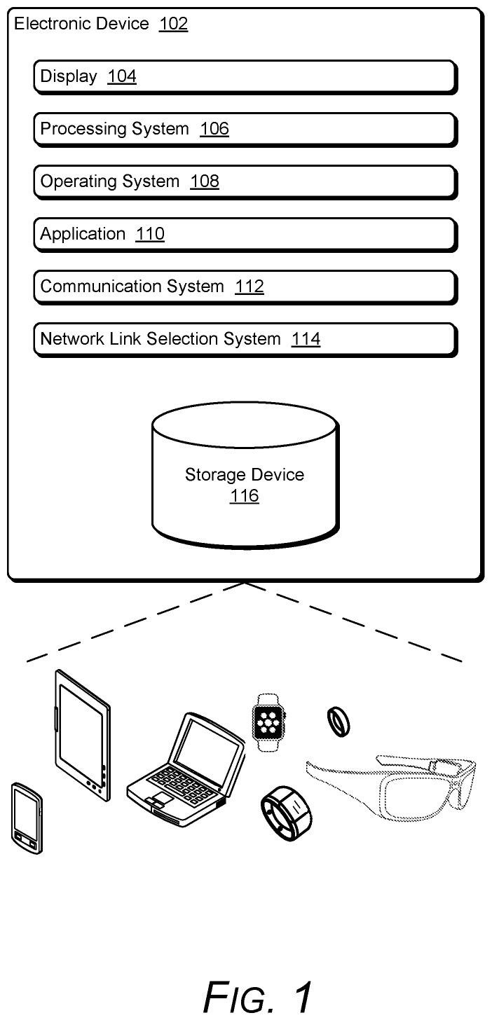

FIG. 1 illustrates an example electronic device 102 implementing the techniques discussed herein. The electronic device 102 can be, or include, many different types of computing or electronic devices. For example, the electronic device 102 can be a smartphone or other wireless phone, a tablet or phablet computer, a laptop computer, a wearable device (e.g., a smartwatch, jewelry (e.g., a ring), an augmented reality headset or device, a virtual reality headset or device), a personal media player, a personal navigating device (e.g., global positioning system), an entertainment device (e.g., a gaming console, a portable gaming device, a streaming media player, a digital video recorder, a music or other audio playback device), a video camera, an Internet of Things (IoT) device, an automotive computer, a standalone mobile hotspot, and so forth.

The electronic device 102 includes a display 104. The display 104 can be configured as any suitable type of display, such as an organic light-emitting diode (OLED) display, active matrix OLED display, liquid crystal display (LCD), in-plane shifting LCD, projector, and so forth. Although illustrated as part of the electronic device 102, it should be noted that the display 104 can be implemented separately from the electronic device 102. In such situations, the electronic device 102 can communicate with the display 104 via any of a variety of wired (e.g., Universal Serial Bus (USB), IEEE 1394, High-Definition Multimedia Interface (HDMI)) or wireless (e.g., WiFi™, Bluetooth™, infrared (IR)) connections. The display 104 can also optionally operate as an input device (e.g., the display 104 can be a touchscreen display).

The electronic device 102 also includes a processing system 106 that includes one or more processors, each of which can include one or more cores. The processing system 106 is coupled with, and may implement functionalities of, any other components or modules of the electronic device 102 that are described herein. In one or more embodiments, the processing system 106 includes a single processor having a single core. Alternatively, the processing system 106 includes a single processor having multiple cores or multiple processors (each having one or more cores).

The electronic device 102 also includes an operating system 108. The operating system 108 manages hardware, software, and firmware resources in the electronic device 102. The operating system 108 manages one or more applications 110 running on the electronic device 102, and operates as an interface between applications 110 and hardware components of the electronic device 102.

The electronic device 102 also includes a communication system 112. The communication system 112 manages communication with various other devices, including sending data to and receiving data from other devices, optionally establishing voice calls with other electronic devices, and so forth. The content of these communications and the recipients of these communications is managed, for example, by an application 110 or the operating system 108. This management of the content can include displaying user interfaces to identify data to send to a recipient, to identify or select sources of data (e.g., a web browser), and so forth.

The communication system 112 supports communication over different types of networks, such as a wireless local area network (e.g., using any of the various IEEE 802.11 (WiFi™) standards), a wide area network or cellular network (e.g., a third generation (3G) network, a 4G network, a 5G network, or a later generation network), combinations thereof, and so forth. When accessing a network (e.g., when the electronic device 102 is registered with the network, logs into the network, etc.), a communication link is established between the electronic device 102 (e.g., the communication system 112) and other devices using that network. This communication link is referred to as a wireless local area network link when the electronic device 102 is transferring data using a wireless local area network, and is referred to as a cellular network link when the electronic device 102 is transferring data using a cellular network.

The electronic device 102 supports operation as a mobile hotspot. Mobile hotspot functionality can be implemented as a separate system or as part of another system, such as the operating system 108, an application 110, and so forth. When operating as a mobile hotspot, the electronic device 102 allows one or more other devices to access a network (e.g., the internet) via the communication system 112. These one or more other devices can be coupled to the electronic device 102 via a wired or wireless coupling. This allows the one or more other devices to use the data connection of the electronic device 102 to access the internet (e.g., access one or more devices in the cloud).

The electronic device 102 also supports operation in a P2P mode. In a P2P mode, the electronic device 102 is able to communicate with other computing devices directly without passing through another server device and typically without passing through an intermediate wireless access point.

The electronic device 102 also includes a network link selection system 114. The electronic device 102 supports operation as a mobile hotspot as well as operation in a P2P mode using a wireless local area network link or a cellular network link. The network link selection system 114 automatically selects which of the wireless local area network link and the cellular network link to use to communicate with another electronic device. This other electronic device can be a server or other device (e.g., on the internet) when operating as a mobile hotspot, or another electronic device (e.g., analogous to electronic device 102) when operating in a P2P mode.

In one or more implementations, when both a wireless local area network link and a cellular network link are available to the electronic device 102, the network link selection system 114 determines the performance of the cellular network link and the performance of the wireless local area network link. These performances can be determined in various manners, as discussed in more detail below. The network link selection system 114 selects the one of those two network links having the higher performance to connect to another device when operating as a mobile hotspot or in a P2P mode.

The network link selection system 114 can be implemented in a variety of different manners. For example, the network link selection system 114 can be implemented as multiple instructions stored on computer-readable storage media and that can be executed by the processing system 106. Additionally or alternatively, the data route selection system can be implemented at least in part in hardware (e.g., as an application-specific integrated circuit (ASIC), a field-programmable gate array (FPGA), an application-specific standard product (ASSP), a system-on-a-chip (SoC), a complex programmable logic device (CPLD), and so forth). Although illustrated as separate from the operating system 108, the network link selection system 114 can be implemented at least in part as part of the operating system 108.

The electronic device 102 also includes a storage device 116. The storage device 116 can be implemented using any of a variety of storage technologies, such as magnetic disk, optical disc, Flash or other solid state memory, and so forth. The storage device 116 can store various program instructions and data for any one or more of the operating system 108, application 110, communication system 112, or network link selection system 114.

It should be noted that in some situations the electronic device 102 need not include all elements illustrated in FIG. 1. For example, if the electronic device 102 is a mobile hotspot, the electronic device may not include the display 104.

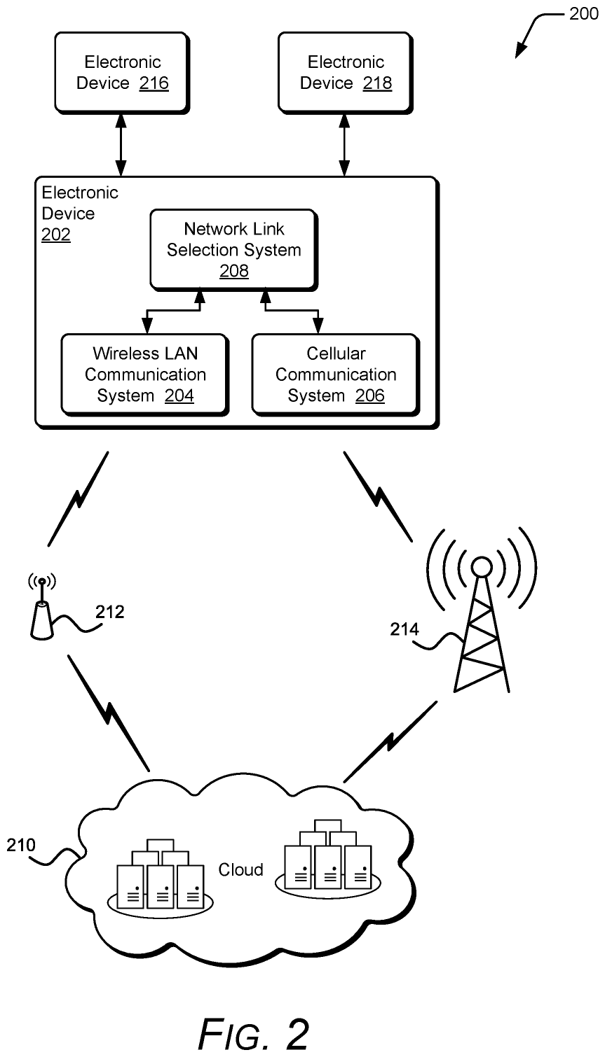

FIG. 2 illustrates an example system 200 implementing the techniques discussed herein. The system 200 illustrates an electronic device 202 including a wireless local area network communication system 204 (also referred to as a wireless LAN communication system), a cellular communication system 206, and a network link selection system 208. The wireless local area network communication system 204 and the cellular communication system 206 can each be part of the communication system 112 of the electronic device 102 of FIG. 1, and the network link selection system 208 can be the network link selection system 114 of the electronic device 102 of FIG. 1.

The wireless local area network communication system 204 supports communication over any of various wireless local area networks, such as a WiFi™ network. The wireless local area network communication system 204 includes hardware, circuitry, firmware, software, or a combination thereof to support access to a wireless local area network (e.g., a WiFi™ network). Examples of such include receiving circuitry, transmitting circuitry, one or more antennas, and so forth. This hardware, circuitry, firmware, software, or a combination thereof supporting access to a wireless local area network allows the wireless local area network communication system 204 to, when in a mobile hotspot mode, transmit data to and receive data from another electronic device in the cloud 210 via a wireless access point 212.

The electronic device 202 supports operation as a mobile hotspot, also referred to as operating in a mobile hotspot mode. Mobile hotspot functionality can be implemented as a separate system or as part of another system, such as the operating system 108, an application 110, and so forth. When operating as a mobile hotspot, the electronic device 202 allows one or more other devices (illustrated as electronic device 216 and electronic device 218) to access a network (e.g., the internet) via the electronic device 202. This allows the electronic devices 216 and 218 to use the data connection of the electronic device 202 to access the internet (e.g., access one or more devices in the cloud). For example, the electronic device 202 receives data from an electronic device 216 or 218 (e.g., via a wired connection, wireless local area network communication system 204, a Bluetooth™ or other wireless connection), transmits the data to a device in the cloud 210 via the selected one of the wireless local area network communication system 204 and the cellular communication system 206. The electronic device 202 also receives data from a device in the cloud 210 via the selected one of the wireless local area network communication system 204 and the cellular communication system 206, and transmits data to the electronic device 216 or 218 (e.g., via a wired connection, wireless local area network communication system 204, a Bluetooth™ or other wireless connection).

The cellular communication system 206 supports communication over any of various cellular networks (also referred to as wide area networks), such as a 3G network, a 4G network, a 5G network, or a later generation network. The cellular communication system 206 includes hardware, circuitry, firmware, software, or a combination thereof to support access to a cellular network (e.g., a 3G network, 4G network, 5G network, or later generation network). Examples of such include receiving circuitry, transmitting circuitry, one or more antennas, and so forth. This hardware, circuitry, firmware, software, or a combination thereof supporting access to a cellular network allows the cellular communication system 206 to transmit data to and receive data from another electronic device in the cloud 210 via a base station 214 (e.g., a NodeB, an eNodeB, a next-generation NodeB (gNB)).

In one or more implementations, when both a wireless local area network link and a cellular network link are available to the electronic device 202 (or available to a mobile hotspot of the electronic device 202), the network link selection system 208 determines the performance of the cellular network link and the performance of the wireless local area network link. The network link selection system 208 selects the one of those two network links having a higher performance to access a network (e.g., the cloud 210) when operating as a mobile hotspot. If only one of the wireless local area network link and the cellular network link are available to the electronic device 102 (or to a mobile hotspot of the electronic device 102), the network link selection system 208 selects the one of the wireless local area network link and the cellular network link that is available.

The performance of a wireless local area network can be determined in any of a variety of manners. In one or more implementations, the performance of the wireless local area network link is the theoretical data throughput of the wireless local area network link. The theoretical data throughput of a wireless local area network link refers to a largest throughput the wireless local area network link is expected or designed to provide. The theoretical data throughput of a wireless local area network link is determined based on a number of transmitters or receivers in the wireless access point 212 that are used by the wireless local area network link and a type of the wireless local area network link. The number of transmitters or receivers in the wireless access point 212 that are used by the wireless local area network link, and the type of the wireless local area network link, is readily available to the network link selection system 208, such as being received by the electronic device 202 from the wireless access point 212 when connecting to the wireless access point 212, being identified based on a make or model number of the wireless access point 212, and so forth. The type of the wireless local area network link refers to, for example, any of the various IEEE 802.11 (WiFi™) standards, such as 802.11b, 802.11g, 802.11n, 802.11ac, 802.11ax, and so forth.

Different types of wireless local area networks and wireless local area network links support different theoretical data throughputs depending on the number of transmitters and receivers the wireless access point 212 is using. For example, if the type of the wireless local area network is 802.11ac and the wireless access point 212 is using one transmitter and one receiver (e.g., a 1×1 configuration), the theoretical data throughput of the wireless local area network link may be 433 megabits per second (Mbps). By way of another example, if the type of the wireless local area network is 802.11ac and the wireless access point 212 is using three transmitters and three receivers (e.g., a 3×3 configuration), the theoretical data throughput of the wireless local area network link may be 1300 Mbps. By way of another example, if the type of the wireless local area network is 802.11g and the wireless access point 212 is using one transmitter and one receiver (e.g., a 1×1 configuration), the theoretical data throughput of the wireless local area network link may be 54 Mbps.

The theoretical data throughputs for wireless access points based on the number of transmitters and receivers the wireless access point is using is readily obtained from various sources, such as being preconfigured in the network link selection system 208, being preconfigured in the operating system 108 of FIG. 1, being received from the wireless access point 212, being obtained from another source (e.g., a remote server, such as a server in the cloud 210), and so forth.

The performance of a cellular network link can be determined in any of a variety of manners. In one or more implementations, the performance of the cellular network link is the theoretical data throughput of the cellular network link. The theoretical data throughput of a cellular network refers to a largest throughput the cellular network link is expected or designed to provide. The theoretical data throughput of a cellular network link is determined based on a generation of the cellular network and a frequency band the cellular network is using. The type of the cellular network and the frequency band the cellular network is using is readily available to the cellular communication system 206, e.g., having been received by the electronic device 202 as part of establishing communication with the base station 214.

Different generations of cellular networks have different theoretical data throughputs, and different frequency bands within a generation of cellular network have different theoretical data throughputs. For example, if the cellular network is a 5G network using band n77, the theoretical data throughput of the cellular network link may be 900 Mbps. By way of another example, if the cellular network is a 5G network using band n96, the theoretical data throughput of the cellular network link may be 1200 Mbps.

The theoretical data throughputs for different frequency bands of different generations of cellular networks is readily obtained from various sources, such as being preconfigured in the network link selection system 208, being preconfigured in the operating system 108 of FIG. 1, being received from the base station 214, being obtained from another source (e.g., a remote server, such as a server in the cloud 210), and so forth.

In one or more implementations, when both a wireless local area network and a cellular network are available to the electronic device 102, the network link selection system 208 determines the performance of the mobile hotspot (e.g., the performance of the electronic device 202 operating as a mobile hotspot or in a mobile hotspot mode). The network link selection system 208 selects the one of the wireless local area network link and the cellular network link having a higher performance to access a network (e.g., the cloud 210) when operating as a mobile hotspot if both the wireless local area network link and the cellular network link have a performance that is greater than the performance of the mobile hotspot. If the performance of the mobile hotspot is less than the performance of the wireless local area network link and the cellular network link, the network link selection system 208 selects a default one of the wireless local area network link and the cellular network link. The default one of the wireless local area network and the cellular network can be preconfigured as, for example, the wireless local area network link, can be selected by a user of the electronic device 202, and so forth.

The performance of the mobile hotspot can be determined in any of a variety of manners. In one or more implementations, the performance of the mobile hotspot is the theoretical data throughput of the mobile hotspot. The theoretical data throughput of a mobile hotspot refers to a largest throughput the mobile hotspot is expected or designed to provide. The theoretical data throughput of a mobile hotspot is determined based on a number of transmitters or receivers in the electronic device 202 that are used by the mobile hotspot and a type of the wireless local area network.

The number of transmitters or receivers in the electronic device 202 that are used by the mobile hotspot can be determined in various manners, such as being received from an application or program on the electronic device 102 providing the mobile hotspot functionality, received from the operating system 108 of FIG. 1, and so forth.

The type of the wireless local area network is readily available to the network link selection system 208, analogous to the discussion above regarding determining the type of the wireless local area network. Given the number of transmitters or receivers in the electronic device 202 that are used by the mobile hotspot and the type of the wireless local area network, the theoretical data throughput of the mobile hotspot can be readily determined analogous to determining the theoretical data throughput of the wireless local area network.

Additionally or alternatively, the performance of a wireless local area network link, cellular network link, mobile hotspot, or combination thereof can be determined in other manners. In one or more implementations, the performance of one or more of the wireless local area network link, cellular network link, or the mobile hotspot is determined using the actual data throughput. For example, data can be transmitted to or received from a server in the cloud 210, and the data throughput readily determined based on an amount of data transferred and an amount of time the data transfer takes. Such measurements can be repeated at various regular or irregular intervals.

In one or more implementations, the performance of one or more of the wireless local area network link, cellular network link, or the mobile hotspot is determined based on previous performance determinations. For example, the performance of one or more of the wireless local area network link, cellular network link, or the mobile hotspot can be determined to be the same as the last time the mobile hotspot was used, the last time the wireless local area network (e.g., the same wireless local area network) was connected to, the last time the cellular network (e.g., the same cellular network or base station 214) was connected to, and so forth.

In one or more implementations, the performance of one or more of the wireless local area network link, cellular network link, or the mobile hotspot is determined based on signal strength. For example, the theoretical data throughput for the wireless local area network link may be reduced if the signal strength between the electronic device 202 and the wireless access point 212 is poor (e.g., below a threshold strength, such as 50% of the maximum signal strength). By way of another example, the theoretical data throughput for the cellular network link may be reduced if the signal strength between the electronic device 202 and the base station 214 is poor (e.g., below a threshold strength, such as 50% of the maximum signal strength).

In one or more implementations, the performance of the wireless local area network link is determined based on the throughput of the wireless access point 212. This throughput may also be referred to as the wireless local area network (WLAN) access point load. The WLAN access point load can be determined by the electronic device 202 (e.g., using any of the IEEE 802.11k or 802.11v protocols) or can be obtained from the wireless access point 212 itself (e.g., the wireless access point 212 knows its load at any given time and can transmit an indication of that load to the electronic device 202).

For example, the network link selection system 208 can determine the WLAN access point load for the wireless access point 212 by scanning for all Wi-Fi channels (such as 36, 40, 44, 48, 149, 153, 157, 161, 165, and so forth) and determining the number of different beacons (specific to BSSID) present in each channel. This allows the network link selection system 208 to identify how many wireless access points are using each particular channel. If any channel is free, e.g., no beacons are present in the channel from any wireless access point, that channel is selected by the network link selection system 208 (e.g., as that channel is the least congested and thus most likely to be able to operate at its theoretical data throughput).

If IEEE 802.11k or 802.11v protocols are used, additional information is available to the network link selection system 208. Using the IEEE 802.11k or 802.11v protocols, the network link selection system 208 can see all the channels that are occupied with one or more wireless access points. The network link selection system 208 does not know how many devices are associated with particular wireless access points and what the data activity is among devices associated with wireless access points. However, the network link selection system 208 can query the wireless access points for radio resource management (RRM) reports or measurements. These reports or measurements can include one or more of a beacon report, a frame report, a channel load report, a noise histogram report, station (STA) statistics, location configuration information (LCI), a neighbor report, a link measurement, or a transmit stream or category measurement. Measurement requests can be made, for example, using the IEEE 802.11k or 802.11v measurement pause mechanism. Reports can be requested, for example, using the measurement pilot mechanism. These reports or measurements allow the electronic device 202 (e.g., the network link selection system 208) to manage and query its radio environment and to make appropriate assessments about channel health and efficiency. This allows the network link selection system 208 to select a clean channel (e.g., that is most likely to be able to operate at its theoretical data throughput).

In one or more implementations, the network link selection system 208 re-evaluates the network links and selects the one of the wireless local area network link and the cellular network link having a higher performance in response to various events. These events include, for example, a change in the wireless local area network link or the wireless access point 212 that the electronic device 202 is connected to, a change in the cellular network link or the base station 214 that the electronic device 202 is connected to, and so forth.

When one of the wireless local area network link and the cellular network link is selected, the electronic device 202 routes data from the electronic device 216 or electronic device 218 to the cloud 210 using the selected one of the wireless local area network link and the cellular network link having a higher performance, and routes data received from the cloud 210 to the electronic device 216 or electronic device 218 using the selected one of the wireless local area network link and the cellular network link having a higher performance.

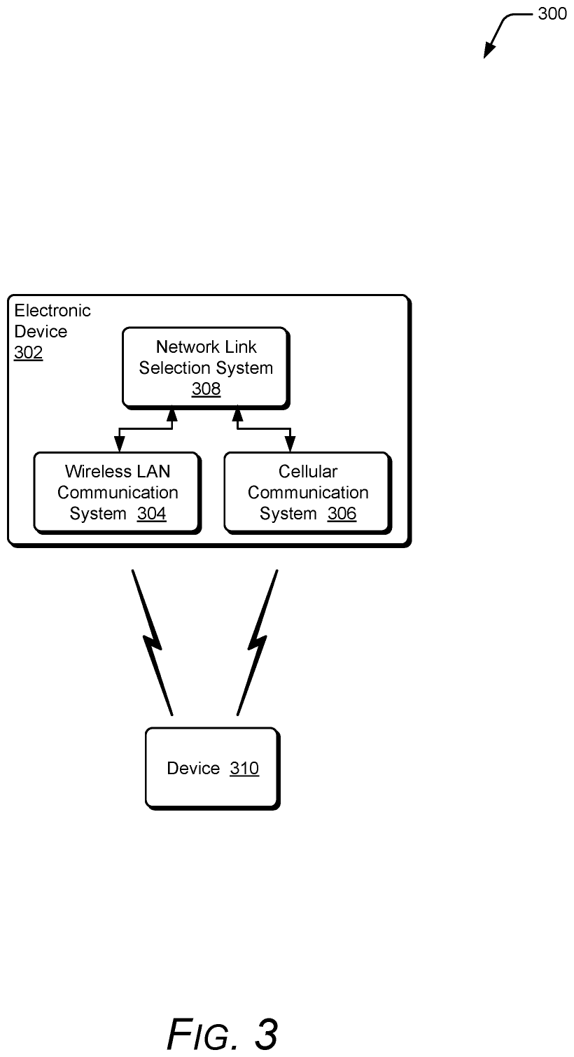

FIG. 3 illustrates an example system 300 implementing the techniques discussed herein. The system 300 illustrates an electronic device 302 including a wireless local area network (wireless LAN) communication system 304, a cellular communication system 306, and a network link selection system 308. The wireless local area network communication system 304 and the cellular communication system 306 can each be part of the communication system 112 of the electronic device 102 of FIG. 1, and the network link selection system 308 can be the network link selection system 114 of the electronic device 102 of FIG. 1.

The electronic device 302 operates analogous to the electronic device 202 of FIG. 2, except that the electronic device 302 is operating in a P2P mode rather than a mobile hotspot mode. In the P2P mode, the electronic device 302 is able to communicate with another electronic device, illustrated as electronic device 310, without passing through another server device and without passing through an intermediate wireless access point. Accordingly, the communication links are between the electronic device 302 and the electronic device 310 rather than between the electronic device 302 and a base station or wireless access point. The performance of the communication links can thus be based on characteristics (e.g., numbers of receivers or transmitters) of the electronic device 310 rather than characteristics of a wireless access point.

The wireless local area network communication system 304 includes hardware, circuitry, firmware, software, or a combination thereof to support access to a wireless local area network (e.g., a WiFi™ network). Examples of such include receiving circuitry, transmitting circuitry, one or more antennas, and so forth. This hardware, circuitry, firmware, software, or a combination thereof supporting access to a wireless local area network allows the wireless local area network communication system 304 to transmit data to and receive data from electronic device 310 (e.g., a device analogous to the electronic device 102 of FIG. 1) when in a P2P mode.

The cellular communication system 306 includes hardware, circuitry, firmware, software, or a combination thereof to support access to a cellular network (e.g., a 3G network, 4G network, 5G network, or later generation network). Examples of such include receiving circuitry, transmitting circuitry, one or more antennas, and so forth. This hardware, circuitry, firmware, software, or a combination thereof supporting access to a cellular network allows the cellular communication system 306 to transmit data to and receive data from electronic device 310.

In one or more implementations, when both a wireless local area network link and a cellular network link are available between the electronic device 302 (or a P2P functionality of the electronic device 302) and the electronic device 310, the network link selection system 308 determines the performance of the cellular network link and the performance of the wireless local area network link. The network link selection system 308 selects the one of those two network links having a higher performance to access the device 310 when operating in a P2P mode. If only one of the wireless local area network link and the cellular network link are available between the electronic device 302 and the electronic device 310, the network link selection system 308 selects the one of the wireless local area network link and the cellular network link that is available.

The performance of a wireless local area network link can be determined in any of a variety of manners analogous to the discussion above regarding FIG. 2, except that the number of transmitters or receivers in the device 310 is used (if the electronic device 302 is communicating directly with the device 310 rather than via a wireless access point) rather than the number of transmitters or receivers in a wireless access point. The number of transmitters or receivers in the device 310 is readily available to the network link selection system 308, such as being received by the electronic device 302 from the electronic device 310. The type of a wireless local area network can be determined in various manners, such as received from a wireless access point that the electronic device 302 communicates with, determined based on a device discovery procedure used to locate the electronic device 310, and so forth.

The performance of a cellular network can be determined in any of a variety of manners analogous to the discussion above regarding FIG. 2.

In one or more implementations, when both a wireless local area network and a cellular network are available to the electronic device 102, the network link selection system 308 determines the performance of the electronic device 302 operating in a P2P mode. The network link selection system 308 selects the one of the wireless local area network and the cellular network having a higher performance to access the electronic device 310 when operating in a P2P mode, if both the wireless local area network link and the cellular network link have a performance that is greater than the performance of the electronic device 302 operating in a P2P mode. If the performance of the electronic device 302 operating in a P2P mode is less than the performance of the wireless local area network and the cellular network, the network link selection system 308 selects a default one of the wireless local area network and the cellular network. The default one of the wireless local area network and the cellular network can be preconfigured as, for example, the wireless local area network, can be selected by a user of the electronic device 302, and so forth.

The performance of the electronic device 302 operating in a P2P mode can be determined in any of a variety of manners. In one or more implementations, the performance of the electronic device 302 operating in a P2P mode is the theoretical data throughput of the electronic device 302 in P2P mode. The theoretical data throughput of the electronic device 302 in P2P mode refers to a largest throughput the mobile P2P functionality is expected or designed to provide. The theoretical data throughput of the electronic device 302 operating in P2P mode is determined based on a number of transmitters or receivers in the electronic device 302 that are used by the electronic device 302 operating in P2P mode and a type of the wireless local area network. The number of transmitters or receivers in the electronic device 302 that are used by the electronic device 302 operating in P2P mode can be determined in various manners, such as being received from an application or program on the electronic device 102 transmitting data to or receiving data from the electronic device 310, received from the operating system 108 of FIG. 1, and so forth.

The type of the wireless local area network is readily available to the network link selection system 208, analogous to the discussion above regarding determining the type of the wireless local area network. Given the number of transmitters or receivers in the electronic device 302 that are used by the electronic device 302 operating in a P2P mode and the type of the wireless local area network, the theoretical data throughput of the electronic device 302 operating in a P2P mode can be readily determined analogous to determining the theoretical data throughput of a mobile hotspot as discussed above.

Additionally or alternatively, the performance of a wireless local area network, cellular network, electronic device in P2P mode, or combination thereof can be determined in other manners, analogous to the discussion above regarding FIG. 2. By way of example, the performance of one or more of the wireless local area network, cellular network, or the electronic device 302 in P2P mode is determined using the actual data throughput. E.g., data can be transmitted to or received from the electronic device 310, and the data throughput readily determined based on an amount of data and an amount of time the data transfer takes.

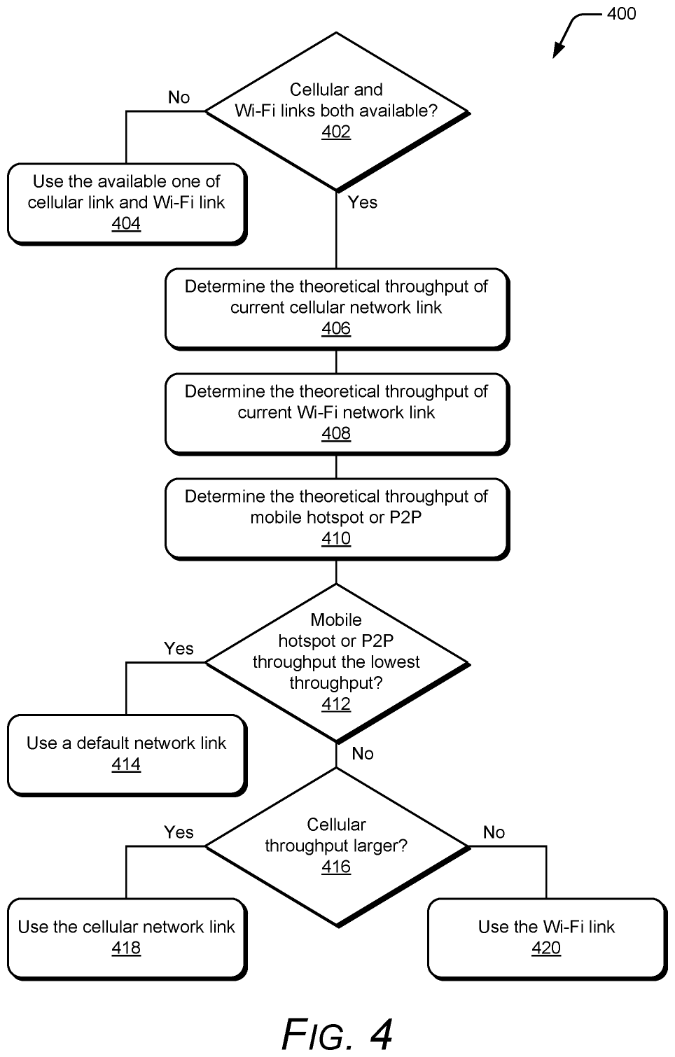

FIG. 4 illustrates an example process 400 for implementing the techniques discussed herein in accordance with one or more embodiments. Process 400 is carried out, for example, by a communication system and a network link selection system, such as communication system 112 and network link selection system 114 of FIG. 1, and can be implemented in software, firmware, hardware, or combinations thereof. Process 400 is shown as a set of acts and is not limited to the order shown for performing the operations of the various acts.

In process 400, a check is made as to whether both a cellular link and a Wi-Fi link is available (act 402). For example, a cellular link is available if the electronic device implementing the process 400 is able to communicate over a cellular network to another electronic device or base station. By way of another example, a Wi-Fi link is available if the electronic device implementing the process 400 is able to communicate using any of the various IEEE 802.11 (WiFi™) standards with another electronic device or wireless access point.

If only one of a cellular link and a Wi-Fi link is available, the available one of the cellular link and the Wi-Fi link is used for communication (act 404).

If both a cellular link and a Wi-Fi link are available, a theoretical throughput of the current cellular network link is determined (act 406).

A theoretical throughput of the current Wi-Fi network link is also determined (act 408).

A theoretical throughput of a mobile hotspot or P2P mode of the electronic device implementing the process 400 is also determined (act 410).

A check is made as to whether the theoretical throughput of the mobile hotspot or P2P mode is the lowest throughput (act 412). Being the lowest throughput refers to the theoretical throughput of the mobile hotspot or P2P mode being lower than the theoretical throughput of the current cellular link and the theoretical throughput of the current Wi-Fi link.

If the theoretical throughput of the mobile hotspot or P2P mode is the lowest throughput, a default network link is used (act 414). The default network link can be, for example, the Wi-Fi network link.

If the theoretical throughput of the mobile hotspot or P2P mode is not the lowest throughput, a check is made as to whether the theoretical throughput of the current cellular link is larger than the theoretical throughput of the current Wi-Fi link (act 416).

If the theoretical throughput of the current cellular link is larger than the theoretical throughput of the current Wi-Fi link, then the current cellular network link is used (act 418).

If the theoretical throughput of the current cellular link is not larger than the theoretical throughput of the current Wi-Fi link, then the current Wi-Fi link is used (act 420).

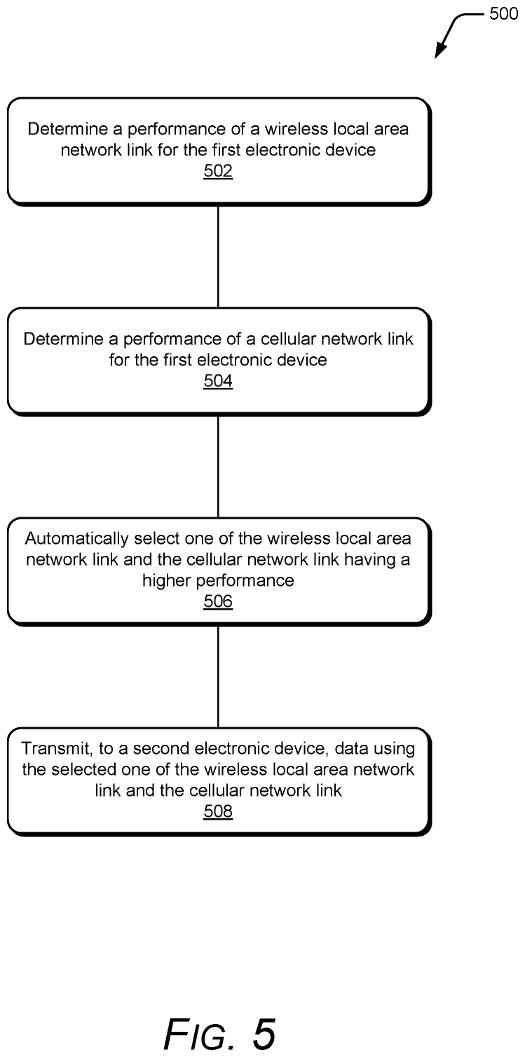

FIG. 5 illustrates an example process 500 for implementing the techniques discussed herein in accordance with one or more embodiments. Process 500 is carried out, for example, by a communication system and a network link selection system, such as communication system 112 and network link selection system 114 of FIG. 1, and can be implemented in software, firmware, hardware, or combinations thereof. Process 500 is shown as a set of acts and is not limited to the order shown for performing the operations of the various acts.

In process 500, a performance of a wireless local area network link for a first electronic device is determined (act 502). The wireless local area network link refers to a communication link between the first electronic device and one or more other electronic devices via a wireless local area network. The wireless local area network is, for example, a network implemented using any of the various IEEE 802.11 (WiFi™) standards.

A performance of a cellular network link for the first electronic device is also determined (act 504). The cellular network link refers to a communication link between the first electronic device and one or more other electronic devices via a cellular network. The cellular network is, for example, a 3G, 4G, 5G, or later generation cellular network.

One of the wireless local area network link and the cellular network link having a higher performance is automatically selected (act 506). The performances of the network links can be, for example, theoretical data throughputs of the network links.

Data is transmitted, to a second electronic device, using the selected one of the wireless local area network link and the cellular network link (act 508).

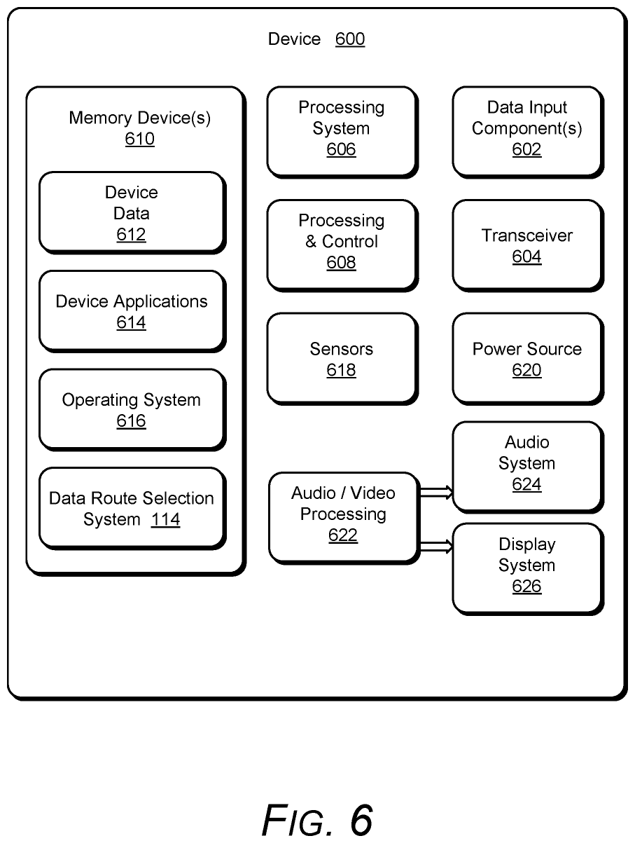

FIG. 6 illustrates various components of an example electronic device that can implement embodiments of the techniques discussed herein. The electronic device 600 can be implemented as any of the devices described with reference to the previous FIG.s, such as any type of client device, mobile phone, tablet, computing, communication, entertainment, gaming, media playback, or other type of electronic device. In one or more embodiments the electronic device 600 includes a network link selection system 114 (which may also be a network link selection system 208 of FIG. 2 or a data route selection system of FIG. 3), described above.

The electronic device 600 includes one or more data input components 602 via which any type of data, media content, or inputs can be received such as user-selectable inputs, messages, music, television content, recorded video content, and any other type of text, audio, video, or image data received from any content or data source. The data input components 602 may include various data input ports such as universal serial bus ports, coaxial cable ports, and other serial or parallel connectors (including internal connectors) for flash memory, DVDs, compact discs, and the like. These data input ports may be used to couple the electronic device to components, peripherals, or accessories such as keyboards, microphones, or cameras. The data input components 602 may also include various other input components such as microphones, touch sensors, touchscreens, keyboards, and so forth.

The device 600 includes communication transceivers 604 that enable one or both of wired and wireless communication of device data with other devices. The device data can include any type of text, audio, video, image data, or combinations thereof. Example transceivers include wireless personal area network (WPAN) radios compliant with various IEEE 802.15 (Bluetooth™) standards, WLAN radios compliant with any of the various IEEE 802.11 (WiFi™) standards, wireless wide area network (WWAN) radios for cellular phone communication, wireless metropolitan area network (WMAN) radios compliant with various IEEE 802.15 (WiMAX™) standards, wired local area network (LAN) Ethernet transceivers for network data communication, and cellular networks (e.g., third generation networks, fourth generation networks such as LTE networks, or fifth generation networks).

The device 600 includes a processing system 606 of one or more processors (e.g., any of microprocessors, controllers, and the like) or a processor and memory system implemented as a system-on-chip (SoC) that processes computer-executable instructions. The processing system 606 may be implemented at least partially in hardware, which can include components of an integrated circuit or on-chip system, an application-specific integrated circuit (ASIC), a field-programmable gate array (FPGA), a complex programmable logic device (CPLD), and other implementations in silicon or other hardware.

Alternately or in addition, the device can be implemented with any one or combination of software, hardware, firmware, or fixed logic circuitry that is implemented in connection with processing and control circuits, which are generally identified at 608. The device 600 may further include any type of a system bus or other data and command transfer system that couples the various components within the device. A system bus can include any one or combination of different bus structures and architectures, as well as control and data lines.

The device 600 also includes computer-readable storage memory devices 610 that enable one or both of data and instruction storage thereon, such as data storage devices that can be accessed by a computing device, and that provide persistent storage of data and executable instructions (e.g., software applications, programs, functions, and the like). Examples of the computer-readable storage memory devices 610 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations. The device 600 may also include a mass storage media device.

The computer-readable storage memory device 610 provides data storage mechanisms to store the device data 612, other types of information or data, and various device applications 614 (e.g., software applications). For example, an operating system 616 can be maintained as software instructions with a memory device and executed by the processing system 606 to cause the processing system 606 to perform various acts. The device applications 614 may also include a device manager, such as any form of a control application, software application, signal-processing and control module, code that is native to a particular device, a hardware abstraction layer for a particular device, and so on.

The device 600 can also include one or more device sensors 618, such as any one or more of an ambient light sensor, a proximity sensor, a touch sensor, an infrared (IR) sensor, accelerometer, gyroscope, thermal sensor, audio sensor (e.g., microphone), and the like. The device 600 can also include one or more power sources 620, such as when the device 600 is implemented as a mobile device. The power sources 620 may include a charging or power system, and can be implemented as a flexible strip battery, a rechargeable battery, a charged super-capacitor, or any other type of active or passive power source.

The device 600 additionally includes an audio or video processing system 622 that generates one or both of audio data for an audio system 624 and display data for a display system 626. In accordance with some embodiments, the audio/video processing system 622 is configured to receive call audio data from the transceiver 604 and communicate the call audio data to the audio system 624 for playback at the device 600. The audio system or the display system may include any devices that process, display, or otherwise render audio, video, display, or image data. Display data and audio signals can be communicated to an audio component or to a display component, respectively, via an RF (radio frequency) link, S-video link, HDMI (high-definition multimedia interface), composite video link, component video link, DVI (digital video interface), analog audio connection, or other similar communication link. In implementations, the audio system or the display system are integrated components of the example device. Alternatively, the audio system or the display system are external, peripheral components to the example device.

Although embodiments of techniques for automatically selecting a network link for transferring data based on link performance have been described in language specific to features or methods, the subject of the appended claims is not necessarily limited to the specific features or methods described. Rather, the specific features and methods are disclosed as example implementations of techniques for implementing automatically selecting a network link for transferring data based on link performance. Further, various different embodiments are described, and it is to be appreciated that each described embodiment can be implemented independently or in connection with one or more other described embodiments. Additional aspects of the techniques, features, and/or methods discussed herein relate to one or more of the following:

In some aspects, the techniques described herein relate to a first electronic device including: at least one memory; and at least one processor coupled with the at least one memory and configured to cause the electronic device to: determine a performance of a wireless local area network link for the first electronic device; determine a performance of a cellular network link for the first electronic device; automatically select one of the wireless local area network link and the cellular network link having a higher performance; and transmit, to a second electronic device, data using the selected one of the wireless local area network link and the cellular network link.

In some aspects, the techniques described herein relate to a first electronic device, wherein the at least one processor is configured to cause the electronic device to: operate as a mobile hotspot; receive data from a third electronic device coupled to the first electronic device; and transmit, in response to the wireless local area network being selected, the data to the second electronic device via a wireless local area network access point.

In some aspects, the techniques described herein relate to a first electronic device, wherein the at least one processor is configured to cause the electronic device to: operate as a mobile hotspot; receive data from a third electronic device coupled to the first electronic device; and transmit, in response to the cellular network link being selected, the data to the second electronic device via a cellular base station.

In some aspects, the techniques described herein relate to a first electronic device, wherein the performance of the wireless local area network link includes a data throughput of a wireless local area network access point, the performance of the cellular network link includes a data throughput of the cellular network link, and the higher performance includes a higher data throughput.

In some aspects, the techniques described herein relate to a first electronic device, wherein the data throughput of the wireless local area network link includes a theoretical data throughput of the wireless local area network link, the data throughput of the cellular network link includes a theoretical data throughput of the cellular network link, and the higher performance includes a higher theoretical data throughput.

In some aspects, the techniques described herein relate to a first electronic device, wherein the theoretical data throughput of the wireless local area network link is based at least in part on a type of the wireless local area network and a number of wireless local area network transmitters and a number of wireless local area network receivers of the wireless local area network access point, and the theoretical data throughput of the cellular network link is based at least in part on a frequency band and a generation of the cellular network link.

In some aspects, the techniques described herein relate to a first electronic device, wherein the at least one processor is configured to cause the electronic device to: determine a performance of the electronic device when operating as a mobile hotspot; and automatically select the one of the wireless local area network link and the cellular network link having the higher performance in response to the performance of the electronic device when operating as a mobile hotspot being lower than the performance of the wireless local area network link lower and the performance of the cellular network link.

In some aspects, the techniques described herein relate to a method implemented at a first electronic device, the method including: determining a performance of a wireless local area network link for the first electronic device; determining a performance of a cellular network link for the first electronic device; automatically selecting one of the wireless local area network link and the cellular network link having a higher performance; and transmitting, to a second electronic device, data using the selected one of the wireless local area network link and the cellular network link.

In some aspects, the techniques described herein relate to a method, further including: operating as a mobile hotspot; receiving data from a third electronic device coupled to the first electronic device; and transmitting, in response to the wireless local area network being selected, the data to the second electronic device via a wireless local area network access point.

In some aspects, the techniques described herein relate to a method, further including: operating as a mobile hotspot; receiving data from a third electronic device coupled to the first electronic device; and transmitting, in response to the cellular network link being selected, the data to the second electronic device via a cellular base station.

In some aspects, the techniques described herein relate to a method, wherein the performance of the wireless local area network link includes a data throughput of a wireless local area network access point, the performance of the cellular network link includes a data throughput of the cellular network link, and the higher performance includes a higher data throughput.

In some aspects, the techniques described herein relate to a method, wherein the data throughput of the wireless local area network link includes a theoretical data throughput of the wireless local area network link, the data throughput of the cellular network link includes a theoretical data throughput of the cellular network link, and the higher performance includes a higher theoretical data throughput.

In some aspects, the techniques described herein relate to a method, wherein the theoretical data throughput of the wireless local area network link is based at least in part on a type of the wireless local area network and a number of wireless local area network transmitters and a number of wireless local area network receivers of the wireless local area network access point, and the theoretical data throughput of the cellular network link is based at least in part on a frequency band and a generation of the cellular network link.

In some aspects, the techniques described herein relate to a method, further including: determining a performance of the electronic device when operating as a mobile hotspot; and automatically selecting the one of the wireless local area network link and the cellular network link having the higher performance in response to the performance of the electronic device when operating as a mobile hotspot being lower than the performance of the wireless local area network link lower and the performance of the cellular network link.

In some aspects, the techniques described herein relate to at least one processor configured to determine a performance of a wireless local area network link for a first electronic device that includes the at least one processor, determine a performance of a cellular network link for the first electronic device, automatically select one of the wireless local area network link and the cellular network link having a higher performance, and transmit, to a second electronic device, data using the selected one of the wireless local area network link and the cellular network link.

In some aspects, the techniques described herein relate to an at least one processor, wherein the at least one processor is configured to operate as a mobile hotspot, receive data from a third electronic device coupled to the first electronic device, and transmit, in response to the wireless local area network being selected, the data to the second electronic device via a wireless local area network access point.

In some aspects, the techniques described herein relate to an at least one processor, wherein the at least one processor is configured to operate as a mobile hotspot, receive data from a third electronic device coupled to the first electronic device, and transmit, in response to the cellular network link being selected, the data to the second electronic device via a cellular base station.

In some aspects, the techniques described herein relate to an at least one processor, wherein the performance of the wireless local area network link includes a data throughput of a wireless local area network access point, the performance of the cellular network link includes a data throughput of the cellular network link, and the higher performance includes a higher data throughput.

In some aspects, the techniques described herein relate to an at least one processor, wherein the data throughput of the wireless local area network link includes a theoretical data throughput of the wireless local area network link, the data throughput of the cellular network link includes a theoretical data throughput of the cellular network link, and the higher performance includes a higher theoretical data throughput.

In some aspects, the techniques described herein relate to an at least one processor, wherein the at least one processor is configured to determine a performance of the electronic device when operating as a mobile hotspot; and automatically select the one of the wireless local area network link and the cellular network link having the higher performance in response to the performance of the electronic device when operating as a mobile hotspot being lower than the performance of the wireless local area network link lower and the performance of the cellular network link.

What is claimed is:

1. A first electronic device comprising:
at least one memory; and
at least one processor coupled with the at least one memory and configured to cause the electronic device to:
determine a performance of a wireless local area network link for the first electronic device;
determine a performance of a cellular network link for the first electronic device;
automatically select one of the wireless local area network link and the cellular network link having a higher performance; and
transmit, to a second electronic device, data using the selected one of the wireless local area network link and the cellular network link.

2. The first electronic device of claim 1, wherein the at least one processor is configured to cause the electronic device to:
operate as a mobile hotspot;
receive data from a third electronic device coupled to the first electronic device; and
transmit, in response to the wireless local area network being selected, the data to the second electronic device via a wireless local area network access point.

3. The first electronic device of claim 1, wherein the at least one processor is configured to cause the electronic device to:
operate as a mobile hotspot;
receive data from a third electronic device coupled to the first electronic device; and
transmit, in response to the cellular network link being selected, the data to the second electronic device via a cellular base station.

4. The first electronic device of claim 1, wherein the performance of the wireless local area network link comprises a data throughput of a wireless local area network access point, the performance of the cellular network link comprises a data throughput of the cellular network link, and the higher performance comprises a higher data throughput.

5. The first electronic device of claim 4, wherein the data throughput of the wireless local area network link comprises a theoretical data throughput of the wireless local area network link, the data throughput of the cellular network link comprises a theoretical data throughput of the cellular network link, and the higher performance comprises a higher theoretical data throughput.

6. The first electronic device of claim 5, wherein the theoretical data throughput of the wireless local area network link is based at least in part on a type of the wireless local area network and a number of wireless local area network transmitters and a number of wireless local area network receivers of the wireless local area network access point, and the theoretical data throughput of the cellular network link is based at least in part on a frequency band and a generation of the cellular network link.

7. The first electronic device of claim 1, wherein the at least one processor is configured to cause the electronic device to:
determine a performance of the electronic device when operating as a mobile hotspot; and
automatically select the one of the wireless local area network link and the cellular network link having the higher performance in response to the performance of the electronic device when operating as a mobile hotspot being lower than the performance of the wireless local area network link lower and the performance of the cellular network link.

8. A method implemented at a first electronic device, the method comprising:
determining a performance of a wireless local area network link for the first electronic device;
determining a performance of a cellular network link for the first electronic device;
automatically selecting one of the wireless local area network link and the cellular network link having a higher performance; and
transmitting, to a second electronic device, data using the selected one of the wireless local area network link and the cellular network link.

9. The method of claim 8, further comprising:
operating as a mobile hotspot;
receiving data from a third electronic device coupled to the first electronic device; and
transmitting, in response to the wireless local area network being selected, the data to the second electronic device via a wireless local area network access point.

10. The method of claim 8, further comprising:
operating as a mobile hotspot;
receiving data from a third electronic device coupled to the first electronic device; and
transmitting, in response to the cellular network link being selected, the data to the second electronic device via a cellular base station.

11. The method of claim 8, wherein the performance of the wireless local area network link comprises a data throughput of a wireless local area network access point, the performance of the cellular network link comprises a data throughput of the cellular network link, and the higher performance comprises a higher data throughput.

12. The method of claim 11, wherein the data throughput of the wireless local area network link comprises a theoretical data throughput of the wireless local area network link, the data throughput of the cellular network link comprises a theoretical data throughput of the cellular network link, and the higher performance comprises a higher theoretical data throughput.

13. The method of claim 12, wherein the theoretical data throughput of the wireless local area network link is based at least in part on a type of the wireless local area network and a number of wireless local area network transmitters and a number of wireless local area network receivers of the wireless local area network access point, and the theoretical data throughput of the cellular network link is based at least in part on a frequency band and a generation of the cellular network link.

14. The method of claim 8, further comprising:
determining a performance of the electronic device when operating as a mobile hotspot; and
automatically selecting the one of the wireless local area network link and the cellular network link having the higher performance in response to the performance of the electronic device when operating as a mobile hotspot being lower than the performance of the wireless local area network link lower and the performance of the cellular network link.

15. At least one processor configured to determine a performance of a wireless local area network link for a first electronic device that includes the at least one processor, determine a performance of a cellular network link for the first electronic device, automatically select one of the wireless local area network link and the cellular network link having a higher performance, and transmit, to a second electronic device, data using the selected one of the wireless local area network link and the cellular network link.

16. The at least one processor of claim 15, wherein the at least one processor is configured to operate as a mobile hotspot, receive data from a third electronic device coupled to the first electronic device, and transmit, in response to the wireless local area network being selected, the data to the second electronic device via a wireless local area network access point.

17. The at least one processor of claim 15, wherein the at least one processor is configured to operate as a mobile hotspot, receive data from a third electronic device coupled to the first electronic device, and transmit, in response to the cellular network link being selected, the data to the second electronic device via a cellular base station.

18. The at least one processor of claim 15, wherein the performance of the wireless local area network link comprises a data throughput of a wireless local area network access point, the performance of the cellular network link comprises a data throughput of the cellular network link, and the higher performance comprises a higher data throughput.

19. The at least one processor of claim 18, wherein the data throughput of the wireless local area network link comprises a theoretical data throughput of the wireless local area network link, the data throughput of the cellular network link comprises a theoretical data throughput of the cellular network link, and the higher performance comprises a higher theoretical data throughput.

20. The at least one processor of claim 15, wherein the at least one processor is configured to determine a performance of the electronic device when operating as a mobile hotspot; and automatically select the one of the wireless local area network link and the cellular network link having the higher performance in response to the performance of the electronic device when operating as a mobile hotspot being lower than the performance of the wireless local area network link lower and the performance of the cellular network link.
